(19) United States
(12) Patent Application Publication
(10) Pub. No.: US 2012/0110437 A1
(43) Pub. Date: May 3, 2012

(54) STYLE AND LAYOUT CACHING OF WEB CONTENT

(75) Inventors: Aimin Pan, Beijing (CN); Bin Benjamin Zhu, Edina, MN (US); Kaimin Zhang, Hefei (CN); Lu Wang, Tianjin (CN)

(73) Assignee: Microsoft Corporation, Redmond, WA (US)

(21) Appl. No.: 12/914,163

(22) Filed: Oct. 28, 2010

(51) Int. Cl. G06F 17/00

(52) U.S. Cl. 715/235

(57) ABSTRACT

Methods and systems for style and/or layout caching of Web content are usable to build reusable style caching trees and cacheable layout calculations. Such style caching trees may be used to avoid recalculating style content of Web pages for document object model (DOM) elements that have not changed. Additionally, the cacheable layout calculations may be used to avoid recalculating the layout content of Web pages that are subsequently accessed.

### BACKGROUND

The World Wide Web (Web) has been ever growing and rapidly expanding since its inception. Additionally, since the widespread household use of personal computers, the Web has gained popularity among consumers and casual users alike. Thus, it is no surprise that the Web has become an enormous repository of data, containing valuable information and various kinds of interactive resources. For example, Web sites often provide up-to-date news and reporting as well as interactive applications that may change dynamically. Web sites may usually be implemented with hypertext markup language (HTML) and JavaScript. The cascade style sheet (CSS) may also be used often in modern Web pages for the flexibility of specifying various visual effects. Displaying a Web site may call for formatting the style and calculating the layout of a Web page file. Unfortunately, many redundant calculations may be performed in order to display such potentially dynamic content, particularly when subsequent requests for the same page are made.

Over time, advances in network technology and hardware infrastructures have significantly increased network speed and decreased overall Internet download times. Additionally, with the advent of multi-core processors, computing devices have become extremely fast and efficient at processing digital content. In many cases, however, a bottleneck may occur at the computing device because a browser may process Web content essentially in a single thread manner and may not exploit the multi-core processors of a modern client device. Additionally, local Web content processing by a browser may include both style formatting and layout calculations. Eliminating redundant operations in style formatting and layout calculation can speed up local Web content processing. Unfortunately, adequate tools do not exist for effectively caching Web style formats and/or layout calculations. Existing caching tools merely cache an entire HTML page and do not help reduce redundant operations in either style formatting or layout calculation.

### BRIEF SUMMARY

This summary is provided to introduce simplified concepts for style and layout caching of Web content, which are further described below in the Detailed Description. This summary is not intended to identify essential features of the claimed subject matter, nor is it intended for use in determining the scope of the claimed subject matter. Generally, the style and layout caching of Web content described herein involves using document object model (DOM) trees constructed from Web page files to create style caching trees which can be used to cache the style formatting of Web pages at a DOM element granularity and/or cache layout calculations performed based at least in part on render trees constructed from the same, or different, Web page files.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of an illustrative method for performing style and layout caching of Web content.

FIG. 2 is a flowchart illustrating a method for implementing the style and layout caching of FIG. 1.

FIGS. 3A-3C are schematic diagrams of an illustrative Web page file along with a corresponding DOM tree for constructing a style caching tree.

FIGS. 4A-4C are schematic diagrams of an illustrative Web page file along with a corresponding DOM tree and style caching tree for illustrating methods of tolerating changes in a DOM tree.

FIG. 5 is a flowchart illustrating methods for implementing style caching.

FIG. 6 is a flowchart illustrating methods for implementing layout caching.

FIG. 7 is a block diagram of a computer environment showing an illustrative system in which a Web content style and layout caching system can be implemented.

### DETAILED DESCRIPTION

### Overview

This disclosure describes style and layout caching for Web content. In particular, systems and recursive methods are presented for creating DOM trees from received Web page files, constructing and caching style caching trees from the DOM trees, performing layout calculations based on render trees, caching the layout calculations, and receiving new Web page files to process. The recursive process may repeat when new Web pages are requested by a Web browser or when changes are found among the style or layout properties of newly received Web page files.

In one aspect, Web page style and layout caching methods may be configured to receive a Web page file, parse the file to create a DOM tree, and construct a style caching tree based at least in part on the DOM tree. In this context, the Web page file may be received from a local memory or from a network storage device or server. Additionally, each DOM tree may contain DOM nodes with parent nodes and/or children nodes. In constructing the style caching tree, style properties may be calculated for each DOM node. Additionally, the style caching tree may be constructed by recursively parsing the DOM tree until each DOM node is represented as a style element. The construction may further include merging sibling style elements that share the same selectors of the CSS rules to be cached. An example of CSS rules to be cached may include rules with the selectors of identifier, class, and tag name as well as the basic descendant and child relationship in the DOM tree. These selectors may be referred to as “normal” selectors. Further, a CSS rule set for the Web page file, the style properties, a matched CSS rule list for each DOM node, along with the style caching tree may be stored in a local cache. Based at least in part on the DOM tree, a render tree may be constructed, and layout calculations may be performed for each render object in the render tree. The resulting layout data may also be stored in a local cache with the corresponding elements in the style caching tree. In this way, successive style formatting and layout calculations, for example when the Web page files and their CSS rule sets that are received at a successive visit of the Web pages, can be checked against the cached content to determine if any redundant calculations may be avoided.

In some instances, only style caching elements with normal selectors will be cached. In other instances, when current DOM nodes match previous DOM nodes, the cached content may be used. Additionally, if current CSS rule sets match previous CSS rule sets, the cached content may be used. In some instances, render boxes, render blocks, render buttons, render text controls, render texts, render images, and inline render objects may be cached. In other instances, when current render tree elements match previous render tree elements, the cached content may be used. When style rules for a current DOM element are different from cached ones, the style of the DOM node may be recalculated. The result may then be cached. When layout features for a current render tree element differ from previous layout features, the layouts for the render tree element may be recalculated. The new results may then be cached.

In another aspect, style caching of Web content may be effectuated by receiving a Web page file, creating a DOM tree from the page file, constructing a smart style caching (SSC) tree based on the DOM tree, and caching the SSC tree. Similarly, in this context, the Web page file may be received from local memory or over a network. Additionally, the SSC tree may be constructed by calculating style properties for each element of the DOM tree, parsing the DOM tree and representing each parsed element as an SSC element in the SSC tree, and merging sibling SSC elements that share the same CSS selectors to be cached. In one instance, CSS rules with normal selectors are cached. The cached SSC tree may be used to avoid recalculating style properties for DOM nodes by determining if rules of current DOM nodes match cached rules of the DOM nodes.

In yet another aspect, a layout caching system may be configured to iteratively receive Web page files, create DOM trees from the Web page files, calculate layout information for nodes of the DOM tree, store the layout information in a local cache, and validate the cached layout information. The system may invalidate cached layout information based on determining that global information of a Web browser has changed, determining that a parent node of a given DOM node has changed, determining that the style information of any DOM node in the DOM tree has changed, or determining that layout-related content of the given DOM node has changed.

As discussed above, many redundant style and formatting calculations are performed when new Web pages are requested by a Web browser or a user. Even worse, traditionally, these redundant recalculations may create a bottleneck at the processing stage for displaying Web content. These problems, and the desire for faster style and layout calculations of Web content, are compounded by the ever increasing number of interactive Web applications found on the Internet.

The techniques described in this disclosure may be used for effectively solving the foregoing problems by caching Web page style and/or layout properties found in associated Web page files. Additionally, the techniques may cache style properties, layout properties, or both style and layout properties together.

A Web browser, or other application stored in a memory of a computing device, may request a Web page from a Web server, or other device for storing Web pages, and may receive a Web page file in response to the request. The Web browser may also receive Web content style specifications in the form of CSS files provided by the creator of the Web page. Generally, a CSS file may be associated with a requested Web page. Alternatively, CSS may be embedded within a Web page file.

A Web browser may also form a DOM tree to represent each element of a Web page file in a tree structure. As such, each element, or tag, in a Web page file may be represented as a single node in the DOM tree. As discussed above, a style caching tree may be formed based, at least in part, on a DOM tree and an associated CSS file. This style caching tree may then be cached to avoid redundant calculations and may be referenced when the same URLs are requested.

Additionally, or alternatively, a render tree may be formed for displaying the Web page on display device. The render tree may be based on a DOM tree. The Web browser may perform layout calculations on DOM tree nodes for a render tree. Calculated layout results may be cached with corresponding nodes in a style caching tree. Much like the style caching, the calculated layout information may be referenced to avoid redundant layout calculations.

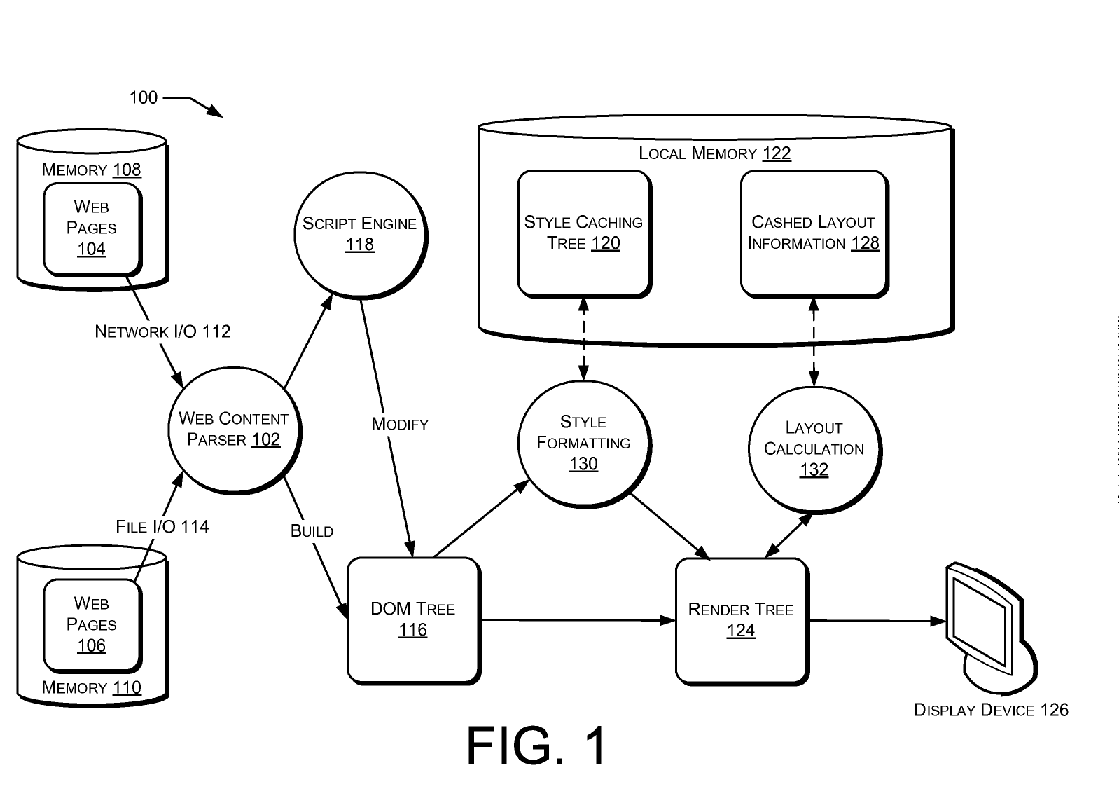

FIG. 1 depicts an illustrative method 100 that may perform style and layout caching of Web content. By way of example only, a Web content parser 102 of a Web browser, or other application, may receive a Web page file 104 or 106 from a memory 108 or 110, respectively. In one example, the Web page file 104 may be located in a network storage device (or server) 108. In this example, the Web content parser 102 may receive the Web page file 104 over a network input/output (I/O) path 112 such as a local network transmission line or the Internet. In another example, the Web page file 106 may be stored in a local memory 110 such as the computing device that implements the Web browser. In this example, the Web content parser 102 may receive the Web page file 106 over a local file I/O path 114 such as a local bus. Additionally, the Web browser may also receive an associated CSS file for each Web page file 104 or each Web page file 104 may contain embedded style information.

In one aspect, the Web content parser 102 may be configured to parse the Web page file 104 to determine individual Web elements. Web elements may be identified based on HTML tags or descriptors found within the Web page file 104. The Web browser may utilize the parsed Web page information from the Web content parser 102 to build a DOM tree 116 for each individual Web page file 104. In this way, the DOM tree 116 can be built based on the parsed elements of the Web page file 104. Additionally, in one aspect, if scripting language code, such as JavaScript™ code, is found within the Web page file 104, the Web browser may serve the script code to a script engine 118. The script engine 118 may be configured to execute the script code, interact with a user of the Web browser, and/or modify the DOM tree 116 based at least in part on the users interactions and/or the executed code. However, if the Web content parser 102 does not detect any script code from within the Web page file 104, the Web browser may build the DOM tree 116 without being modified by the script engine 118.

The Web browser may build a render tree 124 based at least in part on the DOM tree 116. In this way, the Web browser may prepare the data for appropriate layout calculations prior to rendering the Web page on a display device 126. In building a render tree 124, style formatting may be applied to the DOM tree to find out style properties for the DOM nodes. In one aspect, a style caching tree 120 may be constructed from the DOM tree 116 to record style formatting results. As noted above, a style caching tree 120 may be used to represent DOM nodes and associated style properties in tree form. However, other data structures such as linked lists, graphs, etc., may be used to represent the DOM nodes and associated style properties. Further, in one example, the Web browser may cache the style caching tree 120 by storing it in a local memory 122. Local memory 122 may be a cache or other local memory location with relatively short read and/or write latencies. In some instances, successive style formatting 130 operations may retrieve the cached style caching tree 120 to eliminate redundant calculations and/or update the cached style caching tree 120.

In one aspect, the Web browser may perform layout calculations for render objects of the render tree 124. By way of example only, the resulting layout information may contain render data for visible elements of the DOM tree. Additionally, in one aspect, the Web browser may cache the layout information at block 128 by storing it in a local memory 122. In one example, the cached layout information 128 may be stored together with the style caching tree 120 to reduce the data to be cached. However, in other examples, the cached layout information 128 may be stored in a different local memory, such as a different cache or a different computer-readable storage device. In some instances, successive layout calculation 132 may retrieve the cached layout information 128 to eliminate redundant calculations and/or update the cached layout information 128.

Additionally, as shown in FIG. 1, the Web browser may serve the render tree 124 with layout information to a display device 126 for displaying the Web page to a user. Alternatively, as displayed by the dashed line between style formatting 130 and style caching tree 120 in FIG. 1, the Web browser may construct a render tree 124 from the DOM tree 116 and apply style formatting without creating or caching the style caching tree 120. In this way, the Web browser may perform layout calculations and cache the layout information at block 128 without caching style caching tree 120. Also, as displayed by the dashed line between layout calculation 132 and cached layout information 128 in FIG. 1, the Web browser may alternatively create and cache a style caching tree 120 without caching the layout information at block 128 in the local memory 122. In this way, the Web page may still perform the layout calculations prior to serving the render tree 124 to the display device 126; however, the layout information may not be cached at block 128.

FIG. 1 provides a simplified example of a suitable method for caching style and layout content of Web pages according to the present disclosure. However, other configurations are also possible. For example, and as described above, while a DOM tree 116 and render tree 124 are described, other data structures may be used to represent the elements of the Web page file 104. Additionally, although not shown as such in FIG. 1, memory 110 and local memory 122 may be the same data storage implementation. Also, while most examples are described with reference to the Web page file 104 received over a network, any Web page file received by the Web browser may be processed for display using the caching principles noted above. Further, the stages of method 100 may be implemented in any order or concurrently to display a Web page on a display device 126.

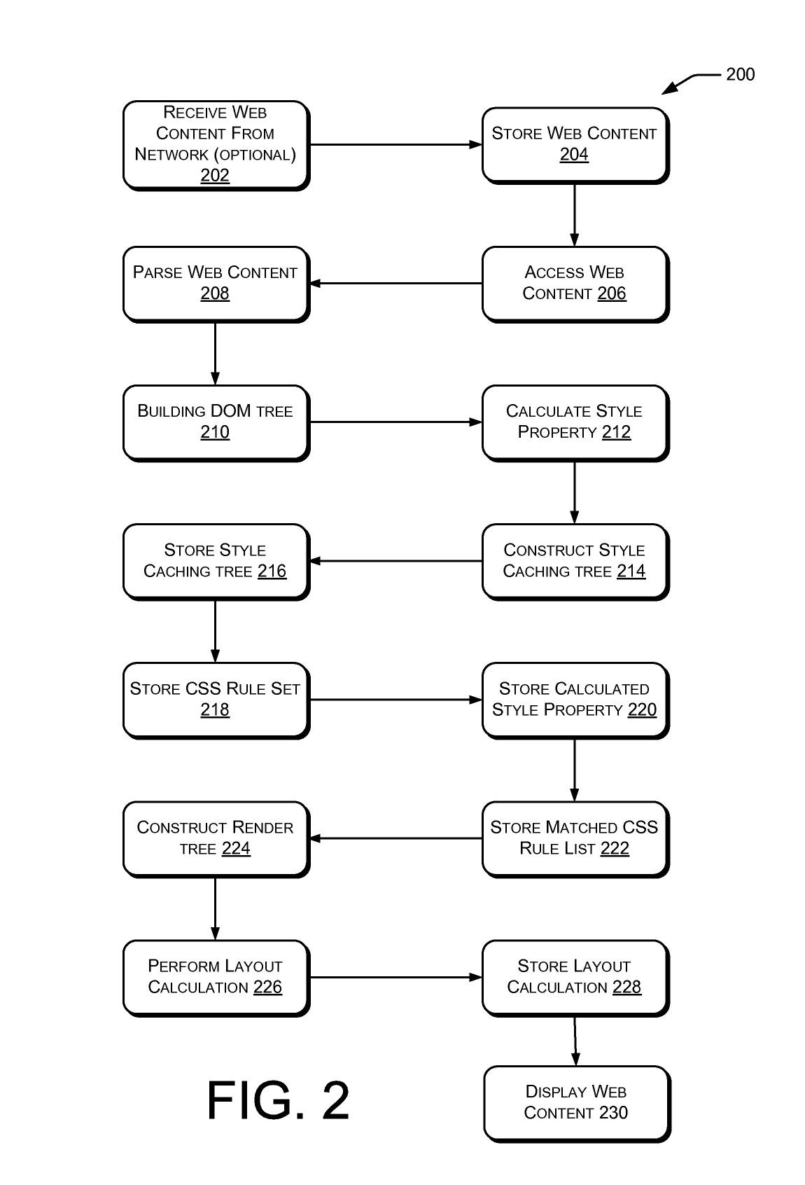

FIG. 2 is a flowchart of one illustrative method 200 for style and layout caching. The method 200 may, but need not necessarily, be implemented in conjunction with the style and layout caching method 100 shown in FIG. 1. In this particular implementation, the method 200 may begin at block 202 in which a Web browser may receive Web content from a network storage device or from a local storage device. In one example, the Web content may be a Web page file consisting of HTML and JavaScript code. The Web browser may store the Web content in a local memory (as HTML cache) at block 204. At block 206, the Web browser may access the Web content for processing and, at block 208, the Web browser may parse the Web content. At block 210, the Web browser may then construct a DOM tree based at least in part on the elements parsed from the Web content. The Web browser may also calculate style properties for each node in the DOM tree at block 212.

At block 214, the Web browser may construct a style caching tree which may contain the calculated style properties for each DOM node and may have merged elements. As noted above, merged elements may be elements that represent more than one sibling DOM node that share the same ID, Class, TagName triple of CSS rule selectors. The Web browser may then store the style caching tree in a cache at block 216. At blocks 218, 220, and 222, the Web browser may also store the CSS rule set for the Web page, the calculated style properties, and a list of matched CSS rules. At block 224, the Web browser may then construct a render tree based at least in part on the information stored from blocks 216-222. Additionally, at block 226, the Web browser may perform layout calculations for each render object in the render tree. At block 228, the Web browser may cache the layout calculations. The method may then terminate at block 230, where the Web browser may display the Web content to a user.

### Illustrative Style Formatting

In some aspects, there may be only one CSS file for each Web page. A CSS file may consist of a set of rules, each rule consisting of at least two parts: a selector and a declaration. The selector of a CSS rule may determine which kind of elements may match the rule. The selector may be simple, such as ID selectors or class selectors, or it may be complex, such as ones that refer to attributes of a DOM node. Thus, developers may define a scope of elements via a selector and then assign specific style values to them. The declaration of a CSS rule, on the other hand, may be a set of values of pre-set style properties, which may determine how selected elements may be displayed. For example, in the CSS rule “p em {color: red},” the selector may be “p em,” which may indicate that <em> elements which are descendants of <p> elements may be selected as the target elements of this particular rule. Additionally, in this example, the declaration part may be “{color: red},” which may define the color property of selected elements as red.

In some aspects, a Web browser may attempt to determine the style of a newly created or modified element. First, the Web browser may check each CSS rule against each DOM node. The selector of a rule may determine whether the rule is a match to the DOM node. Second, matched rules may be applied to the DOM element in a particular order defined in the CSS specification, to generate the style properties of each DOM node.

In one example, the following Web page file:

<html>
<head>

<style>

| | |
|---|---|
| p em | { color : red } |
| p | { color : green } |
| em | { color : blue } |

</style>

</head>
<body>

<p> The first part <em> The second part </em> </p>

</body>
</html>

may be received by a Web browser for displaying content on a display device.

In this example, three rules are bracketed by the <style> and </style> tags. In order to render the <em> element, a Web browser may determine the style of the element. The Web browser may first check each CSS rule provided in the Web page file against the <em> element. In one example, the Web browser may determine that both the first and third rules are a match. According to the CSS specification, these two elements may then be merged. In this case, only the color property is specified by the page author, while other style properties are set as defaults. Additionally, in this example, both matched rules specify the color property and, thus, according to the CSS specification, the value declared in the first rule may be used because it may have a higher priority. Thus, in this example, the text, “The second part” may be displayed in red rather than in blue.

### Illustrative Style Caching

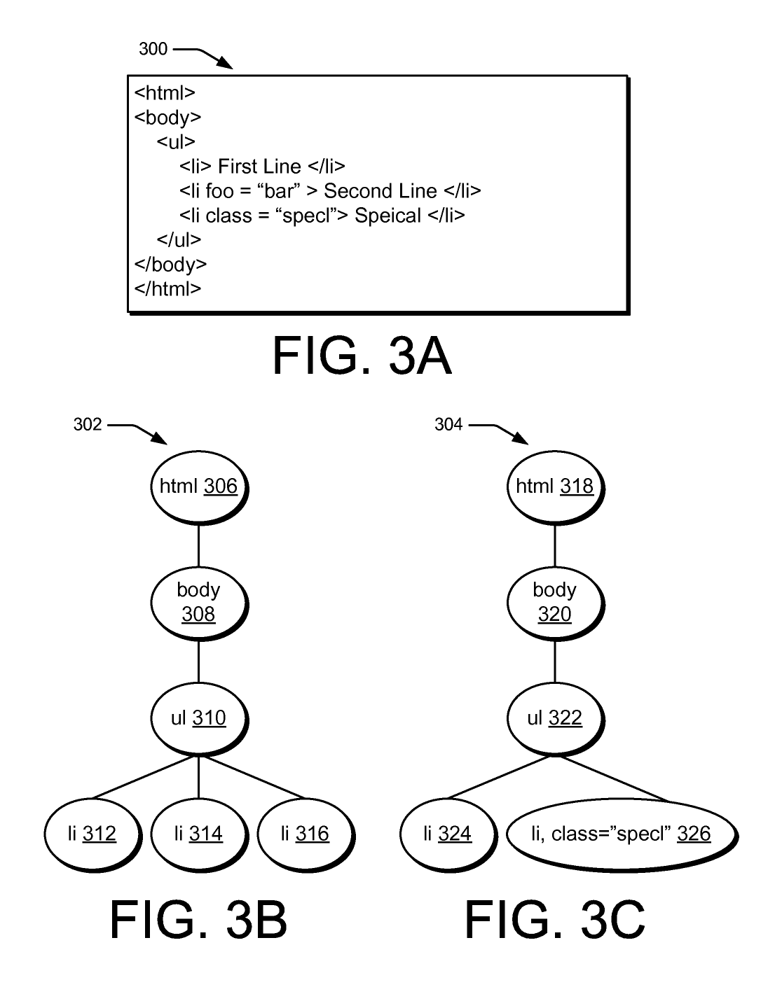

FIGS. 3A-3C illustrate an example Web page file 300 along with a corresponding DOM tree 302 and style caching tree 304. As noted above, and by way of example only, style caching may be implemented by a Web browser. In this example, the Web browser may construct a DOM tree 302 based at least in part on a Web page file. Subsequently, the Web browser may construct a style caching tree 304 based at least in part on the DOM tree. The Web browser may cache a style caching tree 304 for later use.

Additionally, style caching methods may consider all types of CSS rule selectors or they may only consider normal selectors. In one example, normal selectors may be defined as those selectors involving ID, Class, TagName attributes of a single element, and basic descendant and child relationship information of DOM nodes.

In some aspects, the style caching tree 304 may be similar to a DOM tree 302. In other aspects, the style caching tree 304 may only store structure information of the DOM tree 302. Additionally, each DOM node may have a corresponding style caching element and each style caching element may contain a list of matched rules with normal selectors for each corresponding DOM node. In some instances, the list may be empty if the DOM node has no matched rules with normal selectors. Further, as noted above, sibling DOM nodes with the same <ID, class, TagName> triple may be merged into one node.

Specifically, FIG. 3A illustrates an example Web page file 300 with three different <li> elements. In constructing the DOM tree 302 of FIG. 3B, a Web browser may insert the first tag—the <html> tag—as the root node of the tree, namely the “html” node 306. The Web browser may subsequently create a child node for the <body> tag at the “body” node 308 and a child node of the “body” node 304 at the “ul” node 308 for the <ul> tag. As noted above, in this example, the <ul> tag of the Web page file 300 contains three different <li> elements. As such, the DOM tree 302 may include the “li” node 312, the “li” node 314, and the “li” node 316.

FIG. 3C illustrates an example style caching tree 304 constructed in a similar fashion to that of the DOM tree 302. For example, the root node is the “html” node 318 based on the Web page file 300. Similarly, the “body” node 320 and the “ul” node 322 correspond to the “body” node 308 and the “ul” node 310 of the DOM tree 302, respectively. However, in this example, the first and second <li> nodes of the DOM tree 302, that is the “li” node 312 and the “li” node 314, correspond to only the “li” node 324 of the style caching tree 304. In one aspect, this may be based on the fact that “foo” may not be a style property that would affect identification of a style caching element. However, based on the special value for the “class” property of the third <li> tag, the third “li” node of the DOM tree 302 may be represented in the style caching tree 304 as the “li, class=‘specl’” node 326. Thus, as noted above, the “li” nodes 312 and 314 may have been merged because they are siblings and they share the same <ID, class, TagName> triple.

As noted above, in some examples, the style caching methods may cache the style caching tree 304 in a local memory in order to avoid redundant style calculations. As such, any element in the style caching tree 304 for which the matched style rules remain the same after the next Web page request may be retrieved from the style cache without any style computation. On the other hand, when the Web page determines that matched style rules have changed, the style properties may be re-calculated. The style caching tree 304 may be updated with the new matched style rules and the calculated style properties.

As previously discussed, each DOM element may correspond to exactly one style caching element; however, the relationship may not be one-to-one. For example, as discussed regarding the “li” nodes 312, 314, 316, 324, and 326, each style caching element may correspond to one or more DOM nodes. Thus, for each style caching element, the Web browser may cache its style rule selectors (i.e., ID, Class, and TagName) that are used to find the matched DOM elements. The Web browser may cache matched rules for each style caching element. Additionally, the Web browser may also cache the style properties that may be retrieved and applied to the unchanged DOM nodes in subsequent visits to the same Web page.

Therefore, by way of example only, given a DOM node “E,” the corresponding style caching element may be located or created based on the following:

Check if E is the root of the DOM tree.
If E is not the root node, since E's parent, referred to as EP, may have already been checked, determine EP's corresponding style caching element, EP_{SSC}.
Check the child elements of EP_{SSC}.
   If a style caching element exists with the same <ID, Class, TagName> triple as E's, then E is associated with the style caching element.
   Otherwise, E is treated as a new element (however, it may also be an existing but modified element), a new style caching element associated with E is created with E's<ID, Class, TagName> triple, and the new style caching element is attached to the style caching tree as a child of EP_{SSC}.
Otherwise, if E is the root node and the style caching element does not match E, then the whole cached style caching tree is invalidated, a new style caching element is created with E's<ID, Class, TagName> triple and is taken as the new root node.
Otherwise, the style caching root element matches E and, therefore, is associated with E.

Additionally, once the Web browser has identified the corresponding style caching element for E, the style properties may be retrieved from the style caching element. In one aspect, if it is a newly created style caching element, then E's style properties may be calculated and recorded into the new style caching element. In this way, the Web browser may ensure that the style properties of an element E₁ that has been calculated during a visit to a Web page may be retrieved in subsequent visits if E₁ appears in the Web page again.

### Illustrative DOM Tree Changes and CSS Rule Set Changes

In some aspects, the style and layout caching methods may be able to tolerate changes to a DOM tree. For example, if the path of a DOM node to the root of the DOM tree does not change, then the path of its corresponding style caching element to the root of the style caching tree may stay the same as well. However, if the path of a DOM node to the root of the DOM tree has changed, then the DOM node as well as its descendant nodes in the DOM tree may no longer be matched in the cached style caching tree.

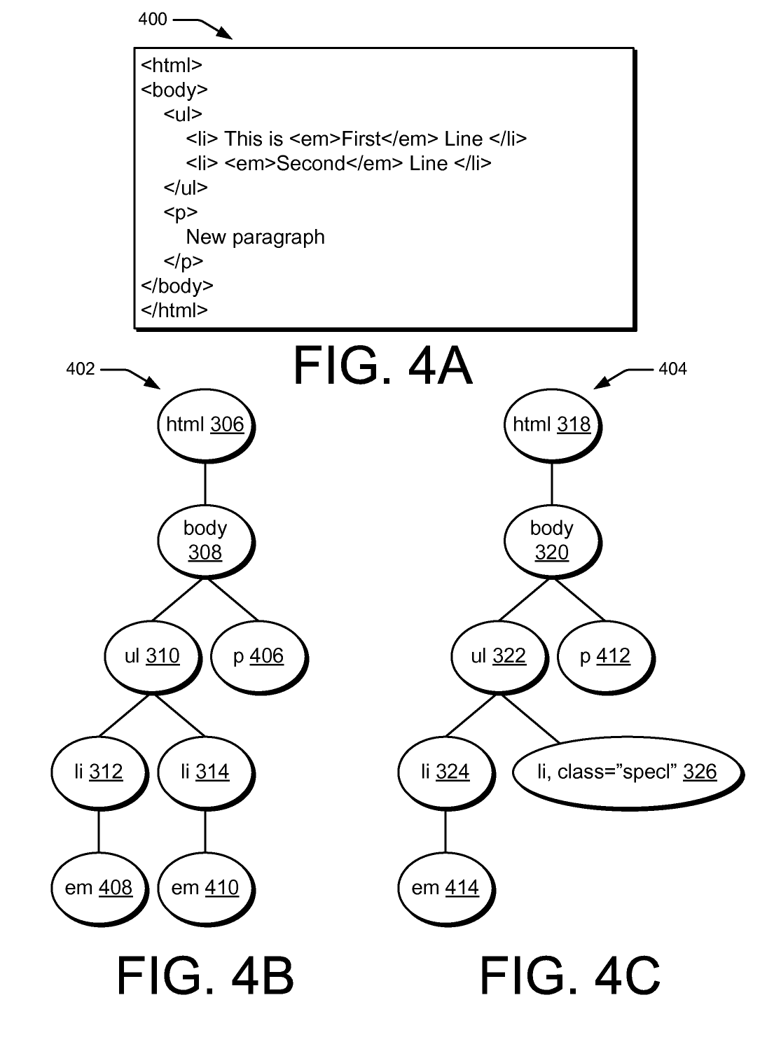

For example, suppose that the Web page file 300 shown in FIG. 3A is modified to become the Web page file 400 shown in FIG. 4A. In this example, the corresponding new DOM tree 402 and style caching tree 404 are shown in FIGS. 4B and 4C, respectively. Additionally, the Web page file 400 includes several additions including a new paragraph signified by the <p> tag and two emphasis elements signified by the <em> tags. On the other hand, the Web page file 400 does not include the third line within the <ul> tags. Thus, the new DOM tree 402 of FIG. 4B differs from the DOM tree 302 of FIG. 3B in that the new DOM tree 402 includes the new “p” node 406, and the new “em” nodes 408 and 410. Additionally, the new DOM tree 402 does not include the “li” node 316 that existed in the DOM tree 302 of FIG. 3B.

In this example, since the “p” node 406 and the two “em” nodes 408 and 410 are new DOM nodes in the DOM tree 402, new style caching elements may be created for them. Here, the “p” node 412 and the “m” node 414 are inserted into the style caching tree 404 to correspond to the new DOM nodes. Additionally, although the two new “em” nodes 408 and 410 are not siblings, they may correspond to the merged “em” node 414 because they may share the same style rules, and their parents, the two “li” nodes 312 and 314 of the DOM tree 402, as noted above with respect to FIGS. 3B and 3C, still correspond to the merged “li” node 324 of the style caching tree 404. Further, the special “li” node 326 of FIG. 3C may still exist in the new style caching tree 404 because the element, although not in the new DOM tree 402, may appear again in future visits to the same Web page. Additionally, in one aspect, it may be possible for the Web page to remove unused style caching elements from the style caching trees 304 and/or 404 periodically to make the style caching trees 304 and/or 404 more compact.

In other aspects, the style and layout caching methods may be able to tolerate changes in CSS rule sets. For example, a style caching tree may record the style properties for each element and also the list of matched rules for each element. Thus, both the style properties and the list of matched rules for each DOM node may be stored in each corresponding style caching element. In some aspects, new CSS rule sets may be identified while they are being received by a Web browser and the following process may be executed for each element:
If there are no new rules in the new rule set (R_{cur}), the cached style properties for the element may be employed directly without any recalculation;
Otherwise, each new rule is examined against the element, and the matched rules are inserted into the list of matched rules of the element. The new list of matched rules may then be used to generate the style properties for the element. In this way, the Web browser can avoid re-checking the selectors of the existing rule set stored in the cache (R_{cache}).

Additionally, once the Web browser has completed loading a new Web page or when the current result is to be displayed in an incremental display mode, the Web browser may be able to identify which rules are missed, i.e., which rules are in R_{cache} but not in R_{cur}. As such, the Web browser may process the elements affected by those rules based on the following:
If there is no missed rule, do nothing;
Otherwise, each node whose matched rule list in the style caching tree contains any of the missed rules may be re-formatted. For each node, the missed rules may be eliminated from its matched rule list.

When styles for DOM nodes are needed, those DOM nodes which have new matched rules which are not in the cached style caching tree, or have some rules deleted from the stored matched rules for the corresponding nodes, may re-calculate their style properties. Once a node has to re-calculate its style properties, all its descendant nodes may also need to re-calculate their style properties. Other DOM nodes may apply the style properties retrieved from the cached style caching tree. The style caching tree may then be updated with the newly calculated style properties.

In this way, the Web browser may be able to identify the same rules that appear in both the current visit to a Web page and the last visit to the same Web page. This may allow the Web browser to avoid duplicating calculations for the elements of which the matched rule list has not changed. Furthermore, the new CSS rules for the current visit may be stored in the style cache to be retrieved for future visits to the same Web page.

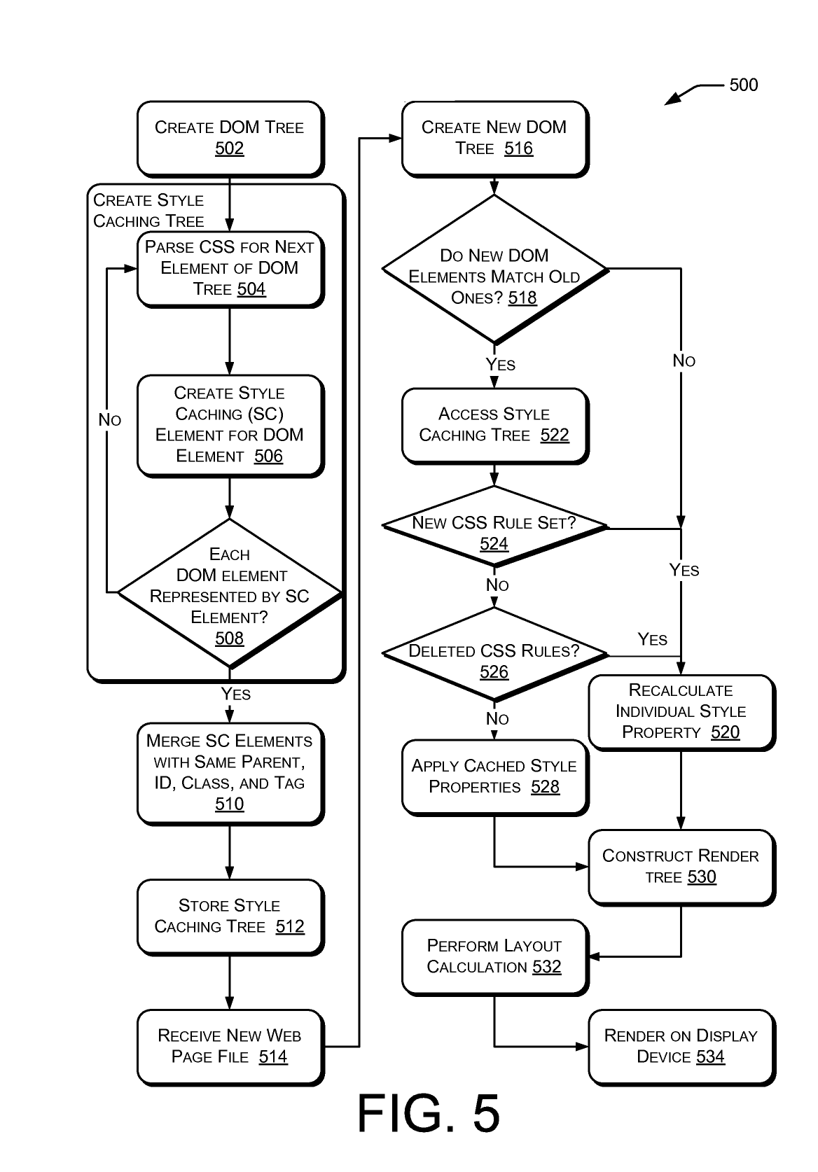

FIG. 5 is a flowchart of one illustrative method 500 for style caching. The method 500 may, but need not necessarily, be implemented in conjunction with the style and layout caching method 100 shown in FIG. 1. In this particular implementation, the method 500 may begin at block 502 in which a Web browser may create a DOM tree by parsing Web content associated with a Web page. The Web browser may then parse the CSS for one DOM tree node at a time to find out matched rules in building a style caching tree at block 504. At block 506, the Web browser may create a style caching element for the particular DOM tree node of block 504. At decision block 508, the Web browser may determine if each DOM node along with its matched style rules has been represented by a style caching node in the new style caching tree. If not, the Web browser may continue to construct the style caching tree by returning to block 504 to continue parsing the next node in the DOM tree. On the other hand, if each DOM node along with its matched style rules has been represented by a style caching node in the style caching tree, the style caching tree may be complete and the method may continue to block 510.

At block 510, the Web browser may merge sibling style caching elements that share the same ID, Class, TagName triple. The Web browser may then cache the style caching tree and calculated style properties in local memory at block 512. At block 514, the Web browser may receive a new Web page file as user makes requests for additional Web pages. At block 516, the Web browser may create a new DOM tree based at least in part on the new Web page file. At decision block 518, the Web browser may determine whether new DOM nodes in the new DOM tree match previous DOM nodes of a previous DOM tree. In one instance, this may be implemented by checking if they have identical paths to their respective roots. If a new DOM node does not match, the Web browser may recalculate individual style properties for the DOM node as well as for its descendant nodes at block 520. Otherwise, for every node in the new DOM tree that matches the old DOM tree, the Web browser may access the style caching tree at block 522.

At decision block 524, the Web browser may determine if the newly received Web page file is accompanied by a new CSS rule set. If so, the Web browser may recalculate the style properties for each element that is affected by the new rule set and also its descendant nodes at block 520. In some instances, only some elements may be affected by such a change; however, in other instances, all elements may be affected. At the end of a page download or when display of the current processed data is requested, deleted CSS rules may be checked at block 526. For rules that appear in cached data but not in the current Web page's CSS rule set, all the matched DOM nodes may be detected. The style properties for these nodes and also their descendant nodes may be re-calculated at block 520. On the other hand, for nodes with their styles not re-calculated at block 520, after checking blocks 526 and 528 (e.g., for the nodes that do not match any new or deleted CSS rules, and where none of their ancestors in the DOM tree have matched any new or deleted CSS rules) the cached style properties may be retrieved at block 528 from the cached style properties, and may be applied without re-calculation. At block 530, the Web browser may construct a render tree based on the DOM tree, and apply the style properties, either re-calculated or retrieved, from the cached style caching tree. The Web browser may perform layout calculations for each element of the render tree at block 532. Finally, at block 534, the method may terminate when the Web browser renders a Web page on a display device based at least in part on the layout calculations and the render tree.

### Illustrative Layout Caching

In one aspect, Web page layout calculations are performed based at least in part on a render tree. As discussed above with reference to FIG. 1, a Web browser may construct a render tree based on a DOM tree. In general, a render tree may have a hierarchical structure similar to a DOM tree and it may include render objects for the visible elements of the DOM tree. In one example, a layout cache may be built atop a render tree by performing layout calculations for each render object in the render tree. The Web browser may then cache the layout calculations in local memory. Thus, when a layout operation is performed during subsequent render objects, the Web browser may determine if the calculation result is already stored in the cache. Otherwise, the Web browser may request a new layout calculation. In this way, redundant layout calculations may be avoided when a cached result will suffice for the current render object.

In one example, the Web browser may identify unchanged render objects in the render in order to reuse the cached layout results. By way of example and not limitation, one way to identify unchanged render objects is to build a companying tree for the render object. Alternatively, another way to identify unchanged render objects is to utilize an existing style caching tree. In this example, each render object may be associated with one DOM node from which it is generated, each DOM node may be associated with one style caching element and, thus, a render object may also be associated with one style caching element. Therefore, the Web browser may record the render object along with its layout result in its associated style caching element. As noted above regarding determining which style caching elements are associated with which DOM nodes, the Web browser may similarly identify a render object in the layout cache by finding its associated DOM node.

In one aspect, layout caching may cache layout calculations for all possible render objects. In another aspect, however, the Web browser may only cache layout results for render boxes, render blocks, render buttons, render text controls, render texts, render images, inline render objects, any combination of the foregoing, or the like.

Additionally, in order to determine validation of the cached layout results a Web browser may perform up to four different validation checks:
1. Global Information of the Browser: This may include the size of the browser's window and the theme of the browser. If the global information of the browser changes, each cached result may be invalidated.
2. Parent-Child Relations in the Render Tree: In the render tree, the layout calculation may be a top-down and recursive procedure, starting from the root of the tree. The layout calculation for a child element may depend on its parent's layout result. For example, an outer box's size may affect the layout of each inner box, and each inner box may be a child of the outer box in the render tree. Therefore, a cache miss on a render object may cause cache misses on the entire sub-tree rooted at that render object.
3. Style of the Render Object: Changes in the style of a render object may invalidate the cached layout calculations for that render object.
4. Content of the Render Object: Layout calculations for a render object may depend on the content of the render object. However, for certain types of render objects, the layout calculation may only be sensitive to part of the content. For example, the size of the image may be the only concern when calculating the layout of an image. Therefore, the hit rate of the layout cache may be improved by only extracting and checking layout-related content.

Additionally, and by way of example only, layout caching may not tolerate changes in the CSS rules of a Web page. Therefore, a Web browser may request a layout re-calculation when changes occur to the CSS rules of a Web page. Alternatively, in some examples, the Web page may be able to access and use cached layout calculations for the nodes that are not affected by the changed CSS rules of a Web page.

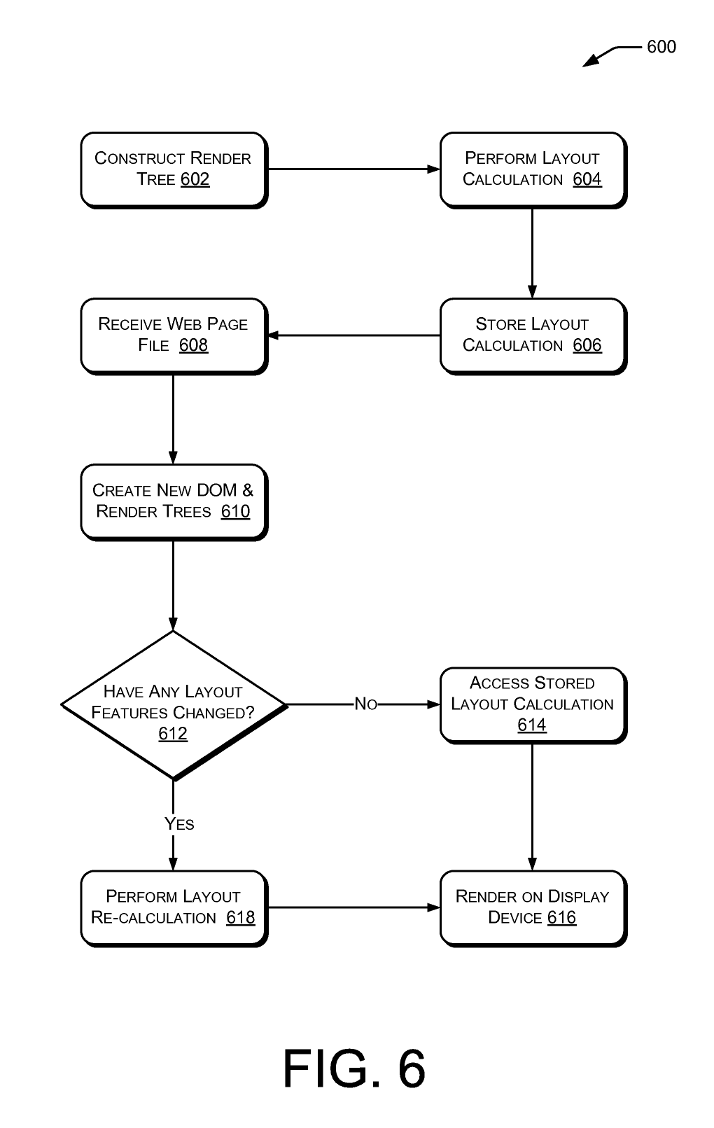

FIG. 6 is a flowchart of one illustrative method 600 for layout caching and cached layout validation. The method 600 may, but need not necessarily, be implemented in conjunction with the style and layout caching method 100 shown in FIG. 1. In this particular implementation, the method 600 may begin at block 602 in which a Web browser may construct a render tree from a DOM tree. At block 604, the Web browser may perform layout calculations for each render object in the render tree. At block 606, the Web browser may cache the results of the layout calculations by storing them in a cache or other local memory storage device.

The Web browser may then receive a new Web page file based on a user's request for a new or updated Web page at block 608. Subsequently, the Web browser may create a new DOM tree based on the newly received HTML file and a new render tree based on the newly created DOM tree at block 610. At decision block 612, the Web browser may determine whether any layout features have changed from the previous render tree to the new render tree. For the nodes for which no change has occurred, the Web browser may access the cached layout calculations at block 614 and apply them without re-calculation. For the nodes for which layout features have changed, the Web browser may perform new layout calculations at block 618. The method may terminate at block 616 by rendering the Web page on a display device based at least in part on the retrieved form of the cached layout properties or newly calculated layout properties and the render tree.

### Illustrative Computing Environment

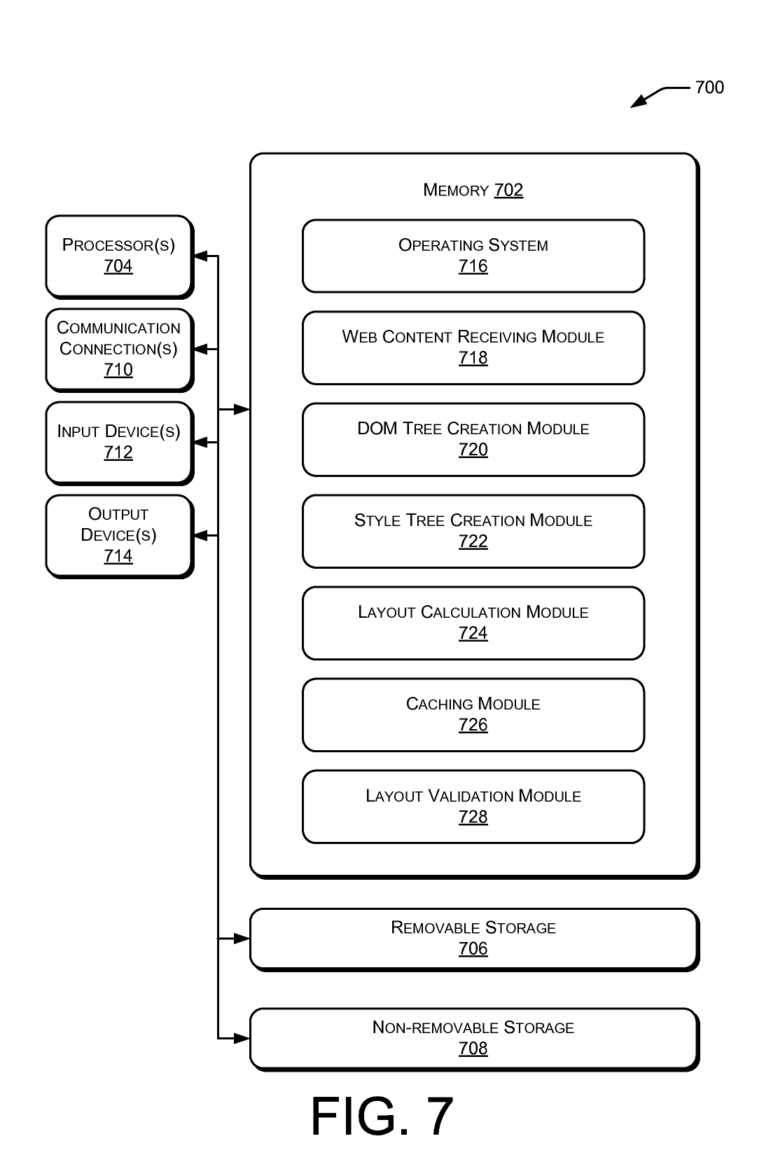

FIG. 7 provides an illustrative overview of one computing environment 700, in which aspects and features disclosed herein may be implemented. The computing environment 700 may be configured as any suitable computing device capable of implementing a Web page style and layout caching system, and accompanying methods, such as, but not limited to those described with reference to FIGS. 1-6. By way of example and not limitation, suitable computing devices may include personal computers (PCs), servers, server farms, datacenters, or any other device capable of storing and executing all or part of the extraction methods.

In one illustrative configuration, the computing environment 700 comprises at least a memory 702 and one or more processing units (or processor(s)) 704. The processor(s) 704 may be implemented as appropriate in hardware, software, firmware, or combinations thereof. Software or firmware implementations of the processor(s) 704 may include computer-executable or machine-executable instructions written in any suitable programming language to perform the various functions described.

Memory 702 may store program instructions that are loadable and executable on the processor(s) 704, as well as data generated during the execution of these programs. Depending on the configuration and type of computing device, memory 702 may be volatile (such as random access memory (RAM)) and/or non-volatile (such as read-only memory (ROM), flash memory, etc.). The computing device or server may also include additional removable storage 706 and/or non-removable storage 708 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 702 may include multiple different types of memory, such as static random access memory (SRAM), dynamic random access memory (DRAM), or ROM.

Memory 702, removable storage 706, and non-removable storage 708 are all examples of computer-readable storage media. Computer-readable storage media includes, but is not limited to, volatile and non-volatile, removable and non-removable media implemented in any method or technology for storage of information such as computer-readable instructions, data structures, program modules or other data. Memory 702, removable storage 706, and non-removable storage 708 are all examples of computer storage media. Additional types of computer storage media that may be present include, but are not limited to, phase change memory (PRAM), SRAM, DRAM, other types of RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server or other computing device. Combinations of any of the above may also be included within the scope of computer-readable storage media.

The computing environment 700 may also contain communications connection(s) 710 that allow the computing environment 700 to communicate with a stored database, another computing device or server, user terminals, and/or other devices on a network. The computing environment 700 may also include input device(s) 712 such as a keyboard, mouse, pen, voice input device, touch input device, etc., and output device(s) 714, such as a display, speakers, printer, etc.

Turning to the contents of the memory 702 in more detail, the memory 702 may include an operating system 716 and one or more application programs or services for implementing Web page style and layout caching including a Web content receiving module 518. The Web content receiving module may be configured to receive Web page files for processing.

The memory 702 may also include a DOM tree creation module 720. The DOM tree creation module 720 may be configured to create a DOM tree by parsing the received Web page file. As discussed above, the DOM tree may represent each element in the Web page file as a node in a hierarchical tree structure or other type of data structure.

The memory 702 may further include a style tree creation module 722. As discussed above, the style tree creation module 722 may be configured to parse each element of the DOM tree, create associated style caching elements, record style properties for each element, and merge elements that share an ID, Class, TagName triple. Additionally, as noted above, the style tree creation module 722 may be configured to embed additional information within the created style tree. Such information may include CSS rule sets, other calculated style properties, matched CSS rule lists, combinations of the foregoing, or the like.

The memory 702 may also include a layout calculation module 724. The layout calculation module 724 may be configured to calculate layout properties for each element in a render tree, along with properties for validation. As discussed above, a Web browser (or any computing device, such as, but not limited to, computing environment 700) may create a render tree based on a DOM tree. Based at least in part on the render tree, the layout calculation module 724 may calculate layout properties for each element of the render tree. In one aspect, these layout properties may be stored back into the render tree.

The memory 702 may further include a caching module 726. The caching module 726 may be configured to store calculation results in a local cache. In one example, the caching module 726 may cache style properties by caching a style tree. In this example, the computing environment 700 may cache the style tree that was previously created by the style tree creation module 720. In other aspects, however, the caching module 726 may cache a style tree provided by a user, a Web server, or the like. In another example, the caching module 726 may cache layout calculations by caching a render tree that includes layout properties for each render object. In this example, the computing environment 700 may cache the layout calculations that were calculated by the layout calculation module 724. Yet, in other aspects, the caching module 726 may cache calculations created and/or served by another entity or module. In yet another example, the caching module 726 may cache both style and layout calculations. As such, in this example, the style and layout calculations may have been performed by the style tree creation module 722 and/or the layout calculation module 724, respectively.

Additionally, the memory 702 may also include a layout validation module 728. The layout validation module 728 may be configured to validate the results of the layout caching. In one aspect, the layout validation module 728 may apply one or more of the four validation checks detailed above. More specifically, the validation module 728 may determine if new layout calculations are to be calculated when a new Web page is requested.

Illustrative methods and systems of multi-threaded parallel web page processing are described above. Some or all of these systems and methods may, but need not, be implemented at least partially by an architecture such as that shown in FIG. 7. It should be understood that certain acts in the methods need not be performed in the order described, may be rearranged, modified, and/or may be omitted entirely, depending on the circumstances. Also, any of the acts described above with respect to any method may be implemented by a processor or other computing device based on instructions stored on one or more computer-readable storage media.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

What is claimed is:

1. A computer-implemented method comprising:
performed by one or more processors executing computer-readable instructions:
receiving a Web page file;
parsing the Web page file to create a document object model (DOM) tree comprising DOM tree nodes;
constructing a style caching tree comprising structure information of the DOM tree;
storing the style caching tree in a memory;
constructing a render tree comprising render objects based at least in part on the structure information of the DOM tree;
performing a layout calculation for render objects; and
storing the layout calculation results in the memory.

2. The computer-implemented method of claim 1, wherein the structure information comprises a parent node and/or a child node for each node in the style caching tree.

3. The computer-implemented method of claim 1, wherein constructing the style caching tree comprises:
recursively parsing the DOM tree until each DOM tree node is represented by a corresponding style caching tree node; and
merging one or more corresponding style caching tree nodes that share a same parent node and a same selector of a selected set of cascading style sheet (CSS) rule selector types into a single merged style caching tree node.

4. The computer-implemented method of claim 3, wherein the selected set of CSS rule selector types comprises selectors of the type: identifier, class, or tag name.

5. The computer-implemented method of claim 3, wherein each style caching tree node comprises a matched CSS rule list and a style property calculated from the matched CSS rule list for at least one of an original corresponding DOM tree node.

6. The computer-implemented method of claim 5, further comprising storing a new CSS rule set for the Web page file in the memory, the new CSS rule set comprising a set of rules of selected CSS rule selector types.

7. The computer-implemented method of claim 6, wherein the selected CSS rule selector types comprise:
identifier, class, or tag name of a single DOM tree node; and
descendant/ancestor relation in the DOM tree.

8. The computer-implemented method of claim 6, further comprising:
receiving a new Web page file from the memory;
parsing the new Web page file to create a new DOM tree comprising new DOM tree nodes;
determining whether nodes in the new DOM tree match the corresponding nodes of a previously created DOM tree;
recalculating a new style property for each node of the new DOM tree that does not match a node of a previously created DOM tree, and for a descendant node in the DOM tree; and
accessing stored style data of the stored style caching tree for each new DOM tree node that matches a node of a previously created DOM tree.

9. The computer-implemented method of claim 8, wherein accessing the stored style data further comprises:
determining whether a new CSS rule set for the new Web page matches the stored CSS rule set;
determining new CSS rules that are not in the stored CSS rule set and deleting CSS rules that are in the stored CSS rule set but are not in the new CSS rule set;
determining the DOM tree nodes that match the new CSS rules or the deleted CSS rules;
recalculating a new style property for each new DOM element that matches the new CSS rule or the deleted CSS rule or recalculating a new style property for each new DOM element ancestor that matches the new CSS rule or the deleted CSS rule; and
accessing the style caching tree to retrieve style properties for the DOM tree nodes without applying recalculation.

10. The computer-implemented method of claim 9, further comprising:
determining whether the new CSS rules are of the selected selector types;
inserting the new CSS rules of the selected selector types into the stored CSS rule set; and
updating the stored style caching tree with the matched rules of the selected selector types and the recalculated new style properties.

11. The computer-implemented method of claim 1, further comprising:
receiving a new Web page;
parsing the new Web page file to create a new DOM tree comprising DOM tree nodes;
determining whether new layout features of the new DOM tree nodes match layout features of the DOM tree nodes of a previously created DOM tree;
performing a layout re-calculation to create recalculated layout information for each render object that corresponds to a DOM tree nodes of a previously created DOM tree with different layout features than those of the new DOM tree node; and
retrieving the stored layout calculation results for each render object that does not need recalculation.

12. The computer-implemented method of claim 11, further comprising:
updating the stored layout calculation results with the new layout features and the recalculated layout information.

13. One or more computer-readable storage media storing computer-executable instructions that, when executed by a processor, perform acts comprising:
receiving a Web page file;
creating a document object model (DOM) tree comprising DOM tree nodes from the Web page file;
constructing a style caching tree based at least in part on the DOM tree; and
caching the style caching tree.

14. The one or more computer-readable storage media of claim 13, wherein the cached style caching tree comprises:
a node containing structural information of a descendant node and an ancestor node of the node in the DOM tree;
a list of matched cascading style sheet (CSS) rules of a selected set of selector types for the node; and
style properties for the node;

15. The one or more computer-readable storage media of claim 13, further comprising:
caching a cascading style sheet (CSS) rule set for the Web page file, comprising rules of selected CSS rule selector types.

16. The one or more computer-readable storage media of claim 15, further comprising:
determining whether a new DOM tree node of a new Web page file matches a DOM tree node of a previously received HTML file;
recalculating a style property for each new DOM tree node that does not match a DOM tree node of a previously received HTML file;
determining whether there the cached CSS rule set has changed for each new DOM tree node that matches a DOM tree node of a previously received HTML file;
recalculating the style property for the new DOM tree node with changes to the cached CSS rule set; and
retrieving the style property from the style caching tree for the new DOM tree node without changing the cached CSS rule set.

17. The one or more computer-readable storage media of claim 13, wherein constructing the style caching tree comprises:
calculating a style property for each DOM element;
parsing the DOM tree until each DOM tree node is represented by a corresponding style caching tree node; and
merging one or more corresponding style caching tree nodes that share a same parent node and a same selector of a selected set of cascading style sheet (CSS) rule selector types.

18. The one or more computer-readable storage media of claim 17, wherein the selected set of CSS rule selector types comprises:
identifier, class, or tag name.

19. A system for implementing layout caching comprising:
memory and one or more processors;
a Web content receiving module, stored in the memory and executable on the one or more processors, configured to receive a Web page file from a local cache memory or a network storage device accessible over a public or private network;
a document object model (DOM) tree creation module, stored in the memory and executable on the one or more processors, configured to create a DOM tree based at least in part on the received Web content file;
a layout calculation module, stored in the memory and executable on the one or more processors, configured to calculate layout information for one or more DOM nodes of the DOM tree;
a layout caching module, stored in the memory and executable on the one or more processors, configured to store the layout information for each DOM tree node in a local cache; and
a layout validation module, stored in the memory and executable on the one or more processors, configured to validate the cached layout information.

20. The system of claim 19, wherein the layout validation module invalidates the cached layout information for a given DOM node based at least in part on:
determining that global information of a Web browser displaying the given DOM node has changed;
determining that a parent node of the given DOM node has changed;
determining that a style of any DOM node in the DOM tree has changed; or
determining that layout-related content of the given DOM node has changed.
